(19) United States
(12) Patent Application Publication
(10) Pub. No.: US 2008/0076692 A1
(43) Pub. Date: Mar. 27, 2008

(54) Laundry compositions

(75) Inventors: Melvin Carvell, Bebington (GB); Anand Ramchandra Mahadeshwar, Hamburg (DE)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/903,473

(22) Filed: Sep. 21, 2007

(30) Foreign Application Priority Data
Sep. 21, 2006 (GB) 0618542.5

(51) Int. Cl. C11D 3/37; C11D 3/20

(52) U.S. Cl. 510/327; 510/276

(57) ABSTRACT

The present invention relates to a softening in the wash composition comprising a detersive surfactant other than soap which has a molecular weight lower than 1000 Daltons, a polymeric non-ionic surfactant with a molecular weight above 2200 Daltons, soap, and a cationic polymer capable of forming a complex with the soap. The invention further relates to a method to increase the deposition of soap onto a fabric surface and to a method to decrease the redeposition of soil onto fabric.

### FIELD OF THE INVENTION

This invention relates to a laundry composition. More particularly, the invention is directed to a softening in the wash laundry composition.

### BACKGROUND OF THE INVENTION

Textile fabrics, including clothes, have traditionally been cleaned with laundry detergents. After cleaning, fabrics can often feel harsh and they will wear and lose colour over repeat wash cycles. To prevent the drawbacks of fabrics feeling harsh after cleaning and those experienced by multiple wash cycles, technologies have been developed including rinse conditioners, softening detergents and anti-dye transfer agents.

However, existing technologies still do not fully prevent such fabric cleaning drawbacks. Thus, there is an ongoing need for products that will condition and protect fabrics from the effects of the washing process.

US 2004/0152617 A1 and US 2004/0152616 are directed to fabric and textile conditioning compounds containing particular combinations of cationic polymers and anionic surfactants.

US 2005/0124528 A1 relates to fabric and textile conditioning compositions with improved particulate soil cleaning, containing particular combinations of cationic polymers and anionic surfactants in combination with a polyvinylpyrrolidone/amphiphilic carboxy containing polymer anti-redeposition system.

There still remains a need for softening laundry detergent compositions that include cationic polymers, and which maintain or improve the softening benefit to fabrics whilst avoiding or otherwise limiting any fabric cleaning negatives especially in respect to the redeposition of soil.

### SUMMARY OF THE INVENTION

In a first aspect, this invention is directed to a softening in the wash detergent composition comprising:—
(a) at least 1% by weight of a detersive surfactant other than soap, with a molecular weight below 1000 Daltons;
(b) at least 1% by weight of a C₆-C₃₀ soap;
(c) 0.005% to 5% by weight of a polymeric non-ionic surfactant having a molecular weight above 2200 Daltons; and,
(d) 0.001% to 15% by weight of one or more cationic polymers capable of forming a complex with (b).

In a second aspect, this invention is directed to a method for increasing the deposition of soap onto a textile, the process comprising the steps:
(a) provision of a softening in the wash laundry composition as described herein; and,
(b) contacting one or more textile articles with the composition at one or more points during the main wash of a laundering process; and,
(c) allowing the textile articles to dry or mechanically tumble-drying them.

In a fourth aspect, the invention is directed to a method to reduce the redeposition of soil onto a textile by
(a) provision of a softening in the wash laundry composition as described herein; and,
(b) contacting one or more textile articles with the composition at one or more points during the main wash of a laundering process; and,
(c) allowing the textile articles to dry or mechanically tumble-drying them.

### DETAILED DESCRIPTION OF THE INVENTION

As used herein, the term “comprising” means including, made up of, composed of, consisting and/or consisting essentially of.

All percentages quoted are wt. % unless otherwise stated.

Except in the operating and comparative examples, or where otherwise explicitly indicated, all numbers in this description indicating amounts or ratios of material or conditions of reaction, physical properties of materials and/or use are to be understood as modified by the word “about”.

As used herein, a formula shall be considered physically “stable” when after 1 week at 21 degrees Celsius it exhibits no signs of phase separation.

The present invention is directed to laundry compositions containing soap, a cationic polymer, a polymeric non-ionic surfactant and another detersive surfactant other than soap. The composition delivers a high level of conditioning to fabrics and also provides fewer cleaning negatives (especially in respect to the redeposition of soil) in comparison to the compositions disclosed in the background art.

### Conditioning Benefits

The compositions of this invention are intended to confer conditioning benefits to garments, home textiles, carpets and other fibrous or fibre-derived articles. These formulations are not to be limited to just conditioning benefits, however, and will often be multi-functional. As such, in addition to conditioning fibre-derived articles, they may also clean, fragrance or otherwise treat them.

The primary conditioning benefit afforded by these products is softening. Softening includes, but is not limited to, an improvement in the handling of a garment treated with the compositions of this invention relative to that of an article laundered under identical conditions but without the use of this invention. Consumers will often describe an article that is softened as “silky” or “fluffy”, and generally prefer the feel of treated garments to those that are unsoftened.

The conditioning benefits of these compositions are not limited to just softening, however. They may, depending on the particular embodiment of the invention selected, also provide an antistatic benefit. In addition to softening, the cationic polymer/anionic surfactant compositions of this invention are further believed to lubricate the fibres of textile articles, which can reduce wear, pilling and colour fading, and provide a shape-retention benefit. This lubricating layer is also believed to provide a substrate on the fabric for retaining fragrances and other benefit agents. Furthermore, it is envisaged that the cationic polymers inhibit the transfer, bleeding and loss of vagrant dyes from fabrics during the wash, preventing the reduction of colour brightness over time.

The invention provides increased cleaning benefits, or otherwise limits any negative cleaning effects of the softening system. One expression of a cleaning benefit is in respect to reducing the redeposition of soil onto fabrics during the laundry process. The anti-redeposition benefit may be characterised by a benefit in the reflectance of the fabric laundered with a composition according to the invention, in comparison to a comparative formulation.

### Form of the Invention

The present invention can take any of a number of forms that are included as main wash products. It can take the form of a laundry treatment agent for the main wash, which may be dilutable or non-dilutable. The laundry treatment agent may be an isotropic liquid, a surfactant-structured liquid, a granular, spray-dried or dry-blended powder, a tablet, a paste, a molded solid or any other laundry detergent form known to those skilled in the art. A “dilutable laundry treatment agent” composition is defined, for the purposes of this disclosure, as a product intended to be used by being diluted with water or a non-aqueous solvent by a ratio of more than 100:1, to produce a liquor suitable for treating textiles and conferring to them one or more conditioning benefits. Water soluble sheets or sachets, such as those described in US Pat. Appl. No. 20020187909, which is incorporated herein by reference, are also envisaged as a potential form of this invention. These may be sold under a variety of names, and for a number of purposes. As such, compositions intended to be used as combination detergent/softeners, along with fabric treatment agents sold for application at the beginning of a wash cycle are all considered within the scope of this invention.

Particularly preferred forms of this invention include combination detergent/softener products, especially as a liquid or solid, for example a powder, and isotropic or surfactant-structured liquid products intended for application as a fabric softener during the wash cycle. The most preferred form of the invention is as a combination detergent/softener product to provide “softening in the wash”.

### Softening in the Wash

By the term “softening in the wash” is meant a composition which provides a fabric softening benefit as well as providing cleaning to the laundered fabric. Such a composition can be added as part of a main wash product, or as a separate product for use in combination with another. However, for the purposes of this disclosure, the composition is intended for use in the main wash cycle. Preferably the softening in the wash composition of the invention is incorporated as part of a single product for use in the main wash.

pH

The preferred pH range of the composition is 2-12. Because many cationic polymers can decompose at high pH, especially when they contain amine or phosphine moieties, it is desirable to keep the pH of the composition below the pKₐ of the amine or phosphine group that is used to quaternise the selected polymer, below which the propensity for this to occur is greatly decreased. This reaction can cause the product to lose effectiveness over time and create an undesirable product odour. As such, a reasonable margin of safety, of 1-2 units of pH below the pKₐ should ideally be used in order to drive the equilibrium of this reaction to strongly favour polymer stability. Although the preferred pH of the product will depend on the particular cationic polymer selected for formulation, typically these values should be below about 8.5 to 10. Wash liquor pH, especially in the case of powdered softener and combination detergent/softener products, can often be less important, as the kinetics of polymer decomposition are often slow, and the time of one wash cycle is typically not sufficient to allow for this reaction to have a significant impact on the performance or odour of the product. A lower pH can also aid in the formulation of higher-viscosity products.

Conversely, as the product depends on the presence of soluble anionic surfactants to provide softening, its pH should preferably be above the pKₐ of the surfactant acids used to formulate it. In addition, aqueous detergent products, which are a highly preferred embodiment of this invention, are nearly impossible to formulate below the pKₐ of the surfactant acids used, as these molecules are rather insoluble in water when in acid form. Again, it is especially desirable to have the pH at least 1-2 units above the pKₐ of the surfactant acids, to ensure that the vast majority of anionic surfactant is present in salt form. Typically, this will suggest that the product pH should be above about 4, although in certain cases, such as when carboxylic acid salts, which often have a pKₐ around 4 or 5, are used, the pH of the product can need to be above about 7 or 8 to ensure effective softening. It is desirable to buffer the formulation at whatever the target pH of the composition is.

### Method of Use

The following details a method for softening textiles comprising the steps, in no particular order of:
a. providing a laundry detergent or fabric softener composition as described herein, comprising soap, at least one cationic polymer, a polymeric no-ionic surfactant and a detersive surfactant other than soap, in a ratio and concentration to effectively soften and condition fabrics under predetermined laundering conditions;
b. contacting one or more articles with the composition at one or more points during the main wash of a laundering process; and
c. allowing the articles to dry or mechanically tumble-drying them,

Amounts of composition used will generally range between about 10 g and about 300 g total product per 3 kg of conditioned fibrous articles, depending on the particular embodiment chosen and other factors, such as consumer preferences, that influence product use behaviour.

A consumer that would use the present invention could also be specifically instructed to contact the fabrics with the inventive composition with the purpose of simultaneously cleaning and softening the said fabrics. This approach would be recommended when the composition takes the form of a softening detergent to be dosed at the beginning of the wash cycle.

### Insoluble Matter

It is preferred that the compositions of this disclosure be formulated with low levels, if any at all, of any matter that is substantially insoluble in the solvent intended to be used to dilute the product. For the purposes of this disclosure, “substantially insoluble” shall mean that the material in question can individually be dissolved at a level of less than 0.001% in the specified solvent. Examples of substantially insoluble matter in aqueous systems include, but are not limited to aluminosilicates, pigments, clays and the like. Without wishing to be bound by theory, it is believed that solvent-insoluble inorganic matter can be attracted and coordinated to the cationic polymers of this invention, which are believed to attach themselves to the articles being washed. When this occurs, it is thought that these particles can create a rough effect on the fabric surface, which in turn reduces the perception of softness.

In addition, as liquid compositions are a possible embodiment of this invention, and insoluble matter is often difficult to formulate into a liquid, it is further desirable to minimise its level in the product. It is therefore desirable to have the liquid compositions be substantially transparent for aesthetic reasons.

Preferably, insoluble and substantially insoluble matter will be limited to less than 10 wt. % of the composition, more preferably 5 wt. %. Most preferably, especially in the case of liquid conditioning compositions, the composition will be essentially free of substantially insoluble matter.

### Composition Ingredients

### Polymeric Non-Ionic Surfactant

A polymeric non-ionic surfactant is included in compositions according to the invention. This non-ionic surfactant is present at a level of 0.005 to 5%, preferably from 0.01 to 4, more preferably from 0.05 to 3.5%, most preferably from 0.075 to 2.5%, for example 0.1 to 2% by weight of total composition. The surfactant can be a single compound, or a mixture of two or more different polymeric non-ionic surfactants.

The surfactant has a molecular weight above 2200 Daltons; preferably it has a molecular weight of less than 13000 Daltons.

The polymeric non-ionic surfactant is understood to be a surface active agent, though it need not be detersive (i.e. perform a cleaning action).

Preferably the polymeric non-ionic surfactant is a block polymer. Preferably it comprises, more preferably consists of, ethylene oxide and propylene oxide blocks as described hereinafter.

### Ethylene Oxide/Propylene Oxide Block Polymers

(EO)ₓ(PO)_{y}(EO)ₓ

or

(PO)ₓ(EO)_{y}(PO)ₓ

wherein EO represents an ethylene oxide unit, PO represents a propylene oxide unit, and x and y are numbers detailing the average number of moles ethylene oxide and propylene oxide in each mole of product. Such materials tend to have higher molecular weights than most non-ionic surfactants, and as such can range between 1000 and 30000 Daltons, although the molecular weight should be above 2200 and preferably below 13000 to be in accordance with the invention. A preferred range for the molecular weight of the polymeric non-ionic surfactant is from 2400 to 11500 Daltons. BASF (Mount Olive, N.J.) manufactures a suitable set of derivatives and markets them under the Pluronic trademarks. Examples of these are Pluronic (trademark) F77, L62 and F88 which have the molecular weight of 6600, 2450 and 11400 Daltons respectively. An especially preferred example of a useful polymeric non-ionic surfactant is Pluronic (trademark) F77.

### Soap

The inventive compositions include soap, herein defined as an alkali or alkaline earth metal salt of a natural or synthetic fatty acid containing between 6 and 30 carbon atoms. Preferably the soap contains between C₈-C₂₆, more preferably C₈-C₂₄, still more preferably C₈-C₁₈ carbon atoms. The incorporation level of the soap is at least 1% by weight of the total composition, preferably from 1 to 25%, more preferably from 1 to 15%, still more preferably from 1.25 to 10%, most preferably from 1.5 to 8% for example from 2 to 6% by weight of the total composition. Particularly preferred forms of soap are outlined below.

### Carboxylic Acid Salts

R¹COOM

where R¹ is a primary or secondary alkyl group of 5 to 29 carbon atoms and M is a solubilising cation. The alkyl group represented by R¹ may represent a mixture of chain lengths and may be saturated or unsaturated, although it is preferred that at least two thirds of the R¹ groups have a chain length of between 7 and 17 carbon atoms. Non-limiting examples of suitable alkyl group sources include the fatty acids derived from coconut oil, tallow, tall oil and palm kernel oil. For the purposes of minimising odour, however, it is often desirable to use primarily saturated carboxylic acids. Such materials are well known to those skilled in the art, and are available from many commercial sources, such as Uniqema (Wilmington, Del.) and Twin Rivers Technologies (Quincy, Mass.). The solubilising cation, M, may be any cation that confers water solubility to the product, although monovalent such moieties are generally preferred. Examples of acceptable solubilising cations for use with this invention include alkali metals such as sodium and potassium, which are particularly preferred, and amines such as triethanolammonium, ammonium and morpholinium. Although, when used, the majority of the fatty acid should be incorporated into the formulation in neutralised salt form, it is often preferable to leave a small amount of free fatty acid in the formulation, as this can aid in the maintenance of product viscosity.

### Detersive Surfactant Other than Soap

A detersive surfactant is herein described as a surfactant (surface active agent) which also provides a detersive function for cleaning and is suitable for laundry products.

The composition of the invention comprises at least 1% by weight of a non-soap detersive surfactant with a molecular weight of below 1000 Daltons. The detersive surfactant may be a single surfactant or a mixture of surfactants. The non-soap detersive surfactant is present at a level of from 1 to 90%, preferably from 1.5 to 85%, more preferably from 2 to 80%, most preferably 4 to 75%, for example 5 to 70%, in particularly 7.5 to 50% and especially 8 to 35% by weight of total composition. In addition to the non-soap detersive surfactant defined above, which is present in compositions of the invention, there may also be present other detersive surfactants, which may have characteristics falling outside the defined values for the non-soap detersive surfactants (i.e. especially other optional detersive surfactants may have a molecular weight above 1000 Daltons).

Suitable surfactants are described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. However, it is preferred if the non-soap detersive surfactant is chosen from non-ionic surfactant, anionic surfactant of mixtures thereof.

Preferred non-ionic surfactants and anionic surfactants are outlined below.

### Anionic Surfactants

The anionic surfactants used in this invention can be any water soluble anionic surfactant other than soap. “Water soluble” surfactants are, unless otherwise noted, here defined to include surfactants which are soluble or dispersible to at least the extent of 0.01% by weight in distilled water at 25° C. “Anionic surfactants” are defined herein as amphiphilic molecules comprising one or more functional groups that exhibit a net anionic charge when in aqueous solution at the normal wash pH of between 6 and 11.

If anionic surfactant is used as whole or part of the detersive non-soap surfactant, then it is preferably present at a level of from 1 to 90%, preferably from 1.5 to 85%, more preferably from 2 to 80%, most preferably 4 to 75%, for example 5 to 70%, in particularly 7.5 to 50% and especially 8 to 35% by weight of total composition. If the anionic surfactant is used as part of the detersive non-ionic surfactant, then preferably the ratio of anionic surfactant to the total amount of other non-soap detersive surfactants is preferably from 10:1 to 1:10, more preferably from 5:1 to 1:5, for example from 4:1 to 1:4.

Preferred anionic surfactants are the alkali metal salts of organic sulphur reaction products having in their molecular structure an alkyl radical containing from about 6 to 24 carbon atoms and a radical selected from the group consisting of sulphonic and sulphuric acid ester radicals.

Although any anionic surfactant hereinafter described can be used, highly preferred anionic surfactants are the alkali and alkaline earth metal salts of either; fatty alcohol sulphates, preferably primary alkyl sulfates, more preferably they are ethoxylated, for example alkyl ether sulfates (such as sodium lauryl ether sulphate), alkylebenzene sulfonates (an example is linear alkylbenzene sulfonate) and mixtures thereof. Some of these aforementioned preferred anionic surfactants are described in more detail below.

### Primary Alkyl Sulphates

R²OSO₃M

where R² is a primary alkyl group of 8 to 18 carbon atoms and M is a solubilising cation. The alkyl group R² may have a mixture of chain lengths. It is preferred that at least two-thirds of the R² alkyl groups have a chain length of 8 to 14 carbon atoms. This will be the case if R² is coconut alkyl, for example. The solubilising cation may be a range of cations which are in general monovalent and confer water solubility. An alkali metal, notably sodium, is especially envisaged. Other possibilities are ammonium and substituted ammonium ions, such as trialkanolammonium or trialkylammonium.

### Alkyl Ether Sulphates

R³O(CH₂CH₂O)ₙSO₃M

where R³ is a primary alkyl group of 8 to 18 carbon atoms, n has an average value in the range from 1 to 6 and M is a solubilising cation. The alkyl group R³ may have a mixture of chain lengths. It is preferred that at least two-thirds of the R³ alkyl groups have a chain length of 8 to 14 carbon atoms. This will be the case if R³ is coconut alkyl, for example. Preferably n has an average value of 2 to 5. Ether sulphates have been found to provide viscosity build in certain of the formulations of this invention, and thus are considered a preferred ingredient.

### Fatty Acid Ester Sulphonates

R⁴CH(SO₃M)CO₂R⁵

where R⁴ is an alkyl group of 6 to 16 atoms, R⁵ is an alkyl group of 1 to 4 carbon atoms and M is a solubilising cation. The group R⁴ may have a mixture of chain lengths.

Preferably at least two-thirds of these groups have 6 to 12 carbon atoms. This will be the case when the moiety R⁸CH(−)CO₂(−) is derived from a coconut source, for instance. It is preferred that R⁵ is a straight chain alkyl, notably methyl or ethyl.

### Alkyl Benzene Sulphonates

R⁶ArSO₃M

where R⁶ is an alkyl group of 8 to 18 carbon atoms, Ar is a benzene ring (C₆H₄) and M is a solubilising cation. The group R⁶ may be a mixture of chain lengths. A mixture of isomers is typically used, and a number of different grades, such as “high 2-phenyl” and “low 2-phenyl” are commercially available for use depending on formulation needs. A plentitude of commercial suppliers exist for these materials, including Stepan (Northfield, Ill.) and Witco (Greenwich, Conn.). Typically they are produced by the sulphonation of alkylbenzenes, which can be produced by either the HF-catalyzed alkylation of benzene with olefins or an AlCl₃-catalyzed process that alkylates benzene with chlor-paraffins, and are sold by, for example, Petresa (Chicago, Ill.) and Sasol (Austin, Tex.). Straight chains of 11 to 14 carbon atoms are usually preferred.

Paraffin sulphonates having 8 to 22 carbon atoms, preferably 12 to 16 carbon atoms, in the alkyl moiety. They are usually produced by the sulphoxidation of petrochemically-derived normal paraffins. These surfactants are commercially available as, for example, Hostapur SAS from Clariant (Charlotte, N.C.). Olefin sulphonates having 8 to 22 carbon atoms, preferably 12 to 16 carbon atoms. U.S. Pat. No. 3,332,880 contains a description of suitable olefin sulphonates, and is incorporated herein by reference. Such materials are sold as, for example, Bio-Terge AS-40, which can be purchased from Stepan (Northfield, Ill.)

### Sulphosuccinate Esters

R⁷OOCCH₂CH(SO₃⁻M⁺)COOR⁸

are also useful in the context of this invention. R⁷ and R⁸ are alkyl groups with chain lengths of between 2 and 16 carbons, and may be linear or branched, saturated or unsaturated. A preferred sulphosuccinate is sodium bis(2-ethylhexyl) sulphosuccinate, which is commercially available under the tradename Aerosol OT from Cytec Industries (West Paterson, N.J.).

Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Also included are non-ionic alkoxylates having a sodium alkylenecarboxylate moiety linked to a terminal hydroxyl group of the non-ionic through an ether bond. Counterions to the salts of all the foregoing may be those of alkali metal, alkaline earth metal, ammonium, alkanolammonium and alkylammonium types.

Other preferred anionic surfactants include the fatty acid ester sulphonates with formula:

R⁹CH(SO₃M)CO₂R¹⁰

where the moiety R⁹CH(−)CO₂(−) is derived from a coconut source and R¹⁰ is either methyl or ethyl; primary alkyl sulphates with the formula:

R¹¹OSO₃M

wherein R¹¹ is a primary alkyl group of 10 to 18 carbon atoms and M is a sodium cation; and paraffin sulphonates, preferably with 12 to 16 carbon atoms to the alkyl moiety.

Other anionic surfactants preferred for use with this formulation include isothionates, sulphated triglycerides, alcohol sulphates, ligninsulphonates, naphthelene sulphonates and alkyl naphthelene sulphonates and the like. Additional anionic surfactants, falling into the general definition but not specifically mentioned above, should also be considered within the scope of this invention.

### Non-Ionic Surfactant

For the purposes of this disclosure, “non-ionic surfactant” shall be defined as amphiphilic molecules which are substantially free of any functional groups that exhibit a net charge at the normal wash pH of 6-11.

If non-ionic surfactant is used as whole or part of the detersive non-soap surfactant, then it is preferably present at a level of from 1 to 90%, preferably from 1.5 to 85%, more preferably from 2 to 80%, most preferably 4 to 75%, for example 5 to 70%, in particularly 7.5 to 50% and especially 8 to 35% by weight of total composition. If the non-ionic surfactant is used as part of the detersive non-ionic surfactant, then preferably the ratio of non-ionic surfactant to the total amount of other non-soap detersive surfactants is preferably from 10:1 to 1:10, more preferably from 5:1 to 1:5, for example from 4:1 to 1:4.

Any type of non-ionic surfactant may be used, although preferred materials are further discussed below. Highly preferred are fatty acid alkoxylates, especially ethoxylates, having an alkyl chain of from C₈-C₃₅, preferably C₈-C₃₀, more preferably C₁₀-C₂₄, especially C₁₀-C₁₈ carbon atoms.

### Fatty Alcohol Ethoxylates

R¹⁸O(EO)ₙ

Wherein R¹⁸ represents an alkyl chain of between 4 and 30 carbon atoms, (EO) represents one unit of ethylene oxide monomer and n has an average value between 0.5 and 20. R may be linear or branched. Such chemicals are generally produced by oligomerizing fatty alcohols with ethylene oxide in the presence of an effective amount catalyst, and are sold in the market as, for example, Neodols from Shell (Houston, Tex.) and Alfonics from Sasol (Austin, Tex.). The fatty alcohol starting materials, which are marketed under trademarks such as Alfol, Lial and Isofol from Sasol (Austin, Tex.) and Neodol, from Shell, may be manufactured by any of a number of processes known to those skilled in the art, and can be derived from natural or synthetic sources or a combination thereof. Commercial alcohol ethoxylates are typically mixtures, comprising varying chain lengths of R¹⁸ and levels of ethoxylation. Often, especially at low levels of ethoxylation, a substantial amount of unethoxylated fatty alcohol remains in the final product, as well.

Because of their excellent cleaning, environmental and stability profiles, fatty alcohol ethoxylates wherein R¹⁸ represents an alkyl chain from 10-18 carbons and n is an average number between 5 and 12 are highly preferred.

### Alkylphenol Ethoxylates

R¹⁹ArO(EO)ₙ

Where R¹⁹ represents a linear or branched alkyl chain ranging from 4 to 30 carbons, Ar is a phenyl (C₆H₄) ring and (EO)ₙ is an oligomer chain comprised of an average of n moles of ethylene oxide. Preferably, R¹⁹ is comprised of between 8 and 12 carbons, and n is between 4 and 12. Such materials are somewhat interchangeable with alcohol ethoxylates, and serve much the same function. A commercial example of an alkylphenol ethoxylate suitable for use in this invention is Triton X-100, available from Dow Chemical (Midland, Mich.)

Other non-ionic surfactants should also be considered within the scope of this invention. These include condensates of alkanolamines with fatty acids, such as cocamide DEA, polyol-fatty acid esters, such as the Span series available from Uniqema (Wilmington, Del.), ethoxylated polyol-fatty acid esters, such as the Tween series available from Uniqema (Wilmington, Del.), Alkylpolyglucosides, such as the APG line available from Cognis (Gulph Mills, Pa.) and n-alkylpyrrolidones, such as the Surfadone series of products marketed by ISP (Wayne, N.J.). Furthermore, non-ionic surfactants not specifically mentioned above, but within the definition, may also be used.

### Water Soluble Cationic Polymer

A water soluble cationic polymer is here defined to include polymers which, because of their molecular weight or monomer composition, are soluble or dispersible to at least the extent of 0.01% by weight in distilled water at 25° C. Water soluble cationic polymers include polymers in which one or more of the constituent monomers are selected from the list of copolymerisable cationic or amphoteric monomers. These monomer units contain a positive charge over at least a portion of the pH range 6-11. A partial listing of monomers can be found in the “International Cosmetic Ingredient Dictionary,” 5th Edition, edited by J. A. Wenninger and G. N. McEwen, The Cosmetic, Toiletry, and Fragrance Association, Washington D.C., 1993, incorporated herein by reference. Another source of such monomers can be found in “Encyclopedia of Polymers and Thickeners for Cosmetics”, by R. Y. Lochhead and W. R. Fron, Cosmetics & Toiletries, vol. 108, May 1993, pp 95-135.

The one or more cationic polymers are present in the softening in the wash composition at a level of from 0.01 to 10%, preferably from 0.025 to 7.5%, more preferably from 0.03 to 5%, for example from 0.05 to 4.5% and especially 0.09 to 2% by weight of total composition.

The cationic polymers of this invention are effective at surprisingly low levels. As such, the ratio of cationic polymer to total surfactant in the composition should preferably be no greater than about 1:5, and more preferably less than about 1:10. The ratio of cationic polymer to anionic surfactant in the composition, on a mass basis, should be less than about 1:4, and ideally less than about 1:10, as well.

The preferred compositions of this invention contain low levels, if any at all, of builder. Generally, these will comprise less than 10%, preferably less than 7% and most preferably less than 5% by weight of total phosphate and zeolite. Furthermore, it is desirable to minimise the amount of certain types of anionic polymers added to the system, as it is believed, without wishing to be bound by theory, that these molecules can complex with the cationic polymers and have a detrimental effect on softening. The preferred compositions of this disclosure comprise less than 2%, more preferably less than 1% and most preferably less than 0.5% anionic polymer. “Anionic polymer” is defined as a molecule with a molecular weight in excess of about 10,000 Daltons comprised of monomer units where at least one of the monomer units making up the polymer contains a negative charge over a portion of the wash pH range of pH 6 to pH 11, those monomer units not containing anionic charges being nonionic in nature.

Specifically, monomers useful in this invention may be represented structurally as etiologically unsaturated compounds as in formula I.

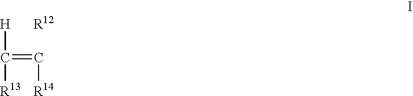

wherein R¹² is hydrogen, hydroxyl, methoxy, or a C₁ to C₃₀ straight or branched alkyl radical; R₁₃ is hydrogen., or a C₁₋₃₀ straight or branched alkyl, a C₁₋₃₀ straight or branched alkyl substituted aryl, aryl substituted C₁₋₃₀ straight or branched alkyl radical, or a polyoxyalkene condensate of an aliphatic radical; and R¹⁴ is a heteroatomic alkyl or aromatic radical containing either one or more quaternised nitrogen atoms or one or more amine groups which possess a positive charge over a portion of the pH interval pH 6 to 11. Such amine groups can be further delineated as having a pKₐ of about 6 or greater.

Examples of cationic monomers of formula I include, but are not limited to, co-poly 2-vinyl pyridine and its co-poly 2-vinyl N-alkyl quaternary pyridinium salt derivatives; co-poly 4-vinyl pyridine and its co-poly 4-vinyl N-alkyl quaternary pyridinium salt derivatives; co-poly 4-vinylbenzyltrialkylammonium salts such as co-poly 4-vinylbenzyltrimethylammonium salt; co-poly 2-vinyl piperidine and co-poly 2-vinyl piperidinium salt; co-poly 4-vinylpiperidine and co-poly 4-vinyl piperidinium salt; co-poly 3-alkyl 1-vinyl imidazolium salts such as co-poly 3-methyl 1-vinyl imidazolium salt; acrylamido and methacrylamido derivatives such as co-poly dimethyl aminopropylmethacrylamide, co-poly acrylamidopropyl trimethylammonium salt and co-poly methacrylamidopropyl trimethylammonium salt; acrylate and methacrylate derivatives such as co-poly dimethyl aminoethyl (meth)acrylate, co-poly ethanaminium N,N,N trimethyl 2-[(1-oxo-2 propenyl) oxy]-salt, co-poly ethanaminium N,N,N trimethyl 2-[(2 methyl-1-oxo-2 propenyl) oxy]-salt, and co-poly ethanaminium N,N,N ethyl dimethyl 2-[(2 methyl-1-oxo-2 propenyl) oxy]-salt.

Also included among the cationic monomers suitable for this invention are co-poly vinyl amine and co-polyvinylammonium salt; co-poly diallylamine, co-poly methyldiallylamine, and co-poly diallydimethylammonium salt; and the ionene class of internal cationic monomers. This class includes co-poly ethylene imine, co-poly ethoxylated ethylene imine and co-poly quaternised ethoxylated ethylene imine; co-poly [(dimethylimino) trimethylene (dimethylimino) hexamethylene disalt], co-poly [(diethylimino) trimethylene (dimethylimino) trimethylene disalt]; co-poly [(dimethylimino) 2-hydroxypropyl salt]; co-polyquarternium-2, co-polyquarternium-17, and co-polyquarternium 18, as defined in the “International Cosmetic Ingredient Dictionary” edited by Wenninger and McEwen.

Additionally, useful polymers are the cationic co-poly amido-amine having the chemical structure of formula II.

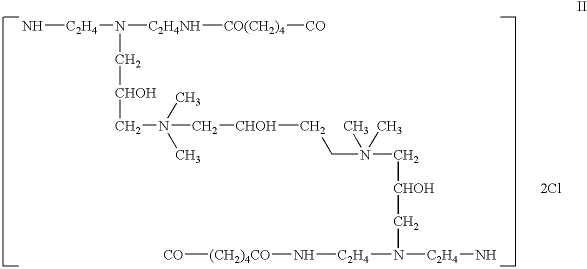

and the quaternised polyimidazoline having the chemical structure of formula III

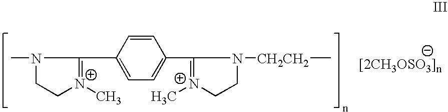

wherein the molecular weight of structures II and III can vary between about 10,000 and 10,000,000 Daltons and each is terminated with an appropriate terminating group such as, for example, a methyl group.

An additional, and highly preferred class of cationic monomers suitable for this invention are those arising from natural sources and include, but are not limited to, cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; guar 2-hydroxy-3-(trimethylammonium) propyl ether salt; cellulose 2-hydroxyethyl 2-hydroxy 3-(trimethyl ammonio) propyl ether salt.

It is likewise envisioned that monomers containing cationic sulphonium salts such as co-poly 1-[3-methyl-4-(vinyl-benzyloxy)phenyl] tetrahydrothiophenium chloride would also be applicable to the present invention.

The counterion of the comprising cationic co-monomer is freely chosen from the halides: chloride, bromide, and iodide; or from hydroxide, phosphate, sulphate, hydrosulphate, ethyl sulphate, methyl sulphate, formate, and acetate.

Another class of cationic polymer useful for the present invention are the cationic silicones. These materials are characterised by repeating dialkylsiloxane interspersed or end terminated, or both, with cationic substituted siloxane units. Commercially available materials of this class are the Abil Quat polymers from Degussa Goldschmidt (Virginia).

The weight fraction of the cationic polymer which is composed of the above-described cationic monomer units can range from 1 to 100%, preferably from 10 to 100%, and most preferably from 15 to 80% of the entire polymer. The remaining monomer units comprising the cationic polymer are chosen from the class of anionic monomers and the class of non-ionic monomers or solely from the class of non-ionic monomers. In the former case, the polymer is an amphoteric polymer while in the latter case it can be a cationic polymer, provided that no amphoteric co-monomers are present. Amphoteric polymers should also be considered within the scope of this disclosure, provided that the polymer unit possesses a net positive charge at one or more points over the wash pH range of pH 6 to 11. The anionic monomers comprise a class of monounsaturated compounds which possess a negative charge over the portion of the pH range from pH 6 to 11 in which the cationic monomers possess a positive charge. The non-ionic monomers comprise a class of monounsaturated compounds which are uncharged over the pH range from pH 6 to 11 in which the cationic monomers possess a positive charge. It is expected that the wash pH at which this invention would be employed would either naturally fall within the above mentioned portion of the pH range 6-11 or, optionally, would be buffered in that range. A preferred class of both the anionic and the non-ionic monomers are the vinyl (ethylenically unsaturated) substituted compounds corresponding to formula IV.

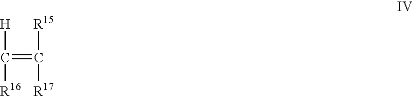

wherein R¹⁵, R¹⁶, and R¹⁷ are independently hydrogen, a C₁ to C₃ alkyl, a carboxylate group or a carboxylate group substituted with a C₁ to C₃₀ linear or branched heteroatomic alkyl or aromatic radical, a heteroatomic radical or a poly oxyalkene condensate of an aliphatic radical.

The class of anionic monomers are represented by the compound described by formula IV in which at least one of the R¹⁵, R¹⁶, or R¹⁷ comprises a carboxylate, substituted carboxylate, phosphonate, substituted phosphonate, sulphate, substituted sulphate, sulphonate, or substituted sulphonate group. Preferred monomers in this class include but are not limited to α-ethacrylic acid, α-cyano acrylic acid, β,β-dimethacrylic acid, methylenemalonic acid, vinylacetic acid, allylacetic acid, acrylic acid, ethylidineacetic acid, propylidineacetic acid, crotonic acid, methacrylic acid, maleic acid, fumaric acid, itaconic acid, sorbic acid, angelic acid, cinnamic acid, β-styryl acrylic acid (1-carboxy-4-phenyl butadiene-1,3), citraconic acid, glutaconic acid, aconitic acid, α-phenylacrylic acid, β-acryloxy propionic acid, citraconic acid, vinyl benzoic acid, N-vinyl succinamidic acid, and mesaconic acid. Also included in the list of preferred monomers are co-poly styrene sulphonic acid, 2-methacryloyloxymethane-1-sulphonic acid, 3-methacryloyloxypropane-1-sulphonic acid, 3-(vinyloxy)propane-1-sulphonic acid, ethylenesulphonic acid, vinyl sulphuric acid, 4-vinylphenyl sulphuric acid, ethylene phosphonic acid and vinyl phosphoric acid. Most preferred monomers include acrylic acid, methacrylic acid and maleic acid. The polymers useful in this invention may contain the above monomers and the alkali metal, alkaline earth metal, and ammonium salts thereof.

The class of non-ionic monomers are represented by the compounds of formula IV in which none of the R¹⁵, R¹⁶, or R¹⁷ contain the above mentioned negative charge containing radicals. Preferred monomers in this class include, but are not limited to, vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); and hydroxyalkyl acrylate esters. A second class of non-ionic monomers include co-poly ethylene oxide, co-poly propylene oxide, and co-poly oxymethylene. A third, and highly preferred, class of non-ionic monomers includes naturally derived materials such as hydroxyethylcellulose and guar gum.

It is highly preferred, and often necessary in the case of certain compositions, to formulate the products of this invention with the proper ratio of cationic polymer to anionic surfactant. Relative to the surface area of the textiles generally laundered, the preferred ratios are unexpectedly low. If the ratio is too high, this can result in reduced softening, poor packing at the interface, unacceptable dissolution times and, in the case of liquid products, an excessively high viscosity which can render the product non-pourable, and thus unacceptable for consumer use. The use of lower ratios of cationic polymer to surfactant also reduces the overall level of polymer necessary for the formulation, which is also preferable for cost and environmental reasons, and gives the formulator greater flexibility in making a stable product. The preferred ratio of cationic polymer:total surfactant will be less than about 1:4, whereas the preferred ratio of cationic polymer:anionic surfactant will be less than about 1:5, and the preferred ratio of cationic polymer:non-ionic surfactant will be less than about 1:5. More preferably, the ratios of cationic polymer:total surfactant, cationic polymer:anionic surfactant and cationic polymer:total surfactant will be less than about 1:10. In terms of absolute fraction, this often means that the concentration of cationic polymer will generally be less than about 5%, preferably less than about 2% and most preferably less than about 1% of the total product mass.

Without wishing to be bound by theory, it is believed that the species responsible for providing a conditioning benefit in these formulations is a polymer/surfactant complex, especially a cationic polymer/soap complex. However said complex, especially when deposited on fabric may lead to an increased attraction of soil to the fabric, and hence an increase redeposition of soil, a perceivable cleaning negative.

Many of the aforementioned cationic polymers can be synthesised in, and are commercially available in, a number of different molecular weights. In order to achieve optimal cleaning and softening performance from the product, it is desirable that the water-soluble cationic or amphoteric, polymer used in this invention be of an appropriate molecular weight. Without wishing to be bound by theory, it is believed that polymers that are too high in mass can entrap soils and prevent them from being removed. The use of cationic polymers with an average molecular weight of less than about 850,000 Daltons, and especially those with an average molecular weight of less than 500,000 Daltons can help to minimise this effect without significantly reducing the softening performance of properly formulated products. On the other hand, polymers with a molecular weight of about 10,000 Daltons or less are believed to be too small to give an effective softening benefit.

In certain cases, especially when these polymers are to be used in a powdered detergent/softener or fabric softener formulation, lower molecular weight polymers can even improve the softening performance of the product. This is believed to be due to dissolution kinetics; materials of too high a molecular weight can fail to dissolve fully during the wash cycle, rendering them unavailable for softening fabrics. The preferred powdered compositions of this invention include materials that have a dissolution parameter of more than about 55.

Cleaning performance can further be improved by selecting a polymer with an appropriate level of cationic moiety. Again, it is believed that polymers with excessive levels of cationic charge can contribute to soil deposition, hindering the cleaning performance of either the fully formulated 2-in-1 detergent/softener or any laundry detergent that is used in conjunction with the compositions of this invention if they are to be standalone fabric softeners. Particularly appropriate materials are those that comprise less than about 2% by weight, preferably less than about 1.8% by weight of cationic nitrogen or phosphorus.

### Optional Ingredients

In addition to the above-mentioned essential elements, the formulation may include one or more optional ingredients. While it is not necessary for these elements to be present in order to practice this invention, the use of such materials is often very helpful in rendering the formulation acceptable for consumer use.

Examples of optional components include, but are not limited to: additional nonionic and anionic surfactants, amphoteric and zwitterionic surfactants, cationic surfactants, hydrotropes, fluorescent whitening agents, photobleaches, fibre lubricants, reducing agents, enzymes, enzyme stabilising agents, powder finishing agents, defoamers, builders, bleaches, bleach catalysts, soil release agents, antiredeposition agents, dye transfer inhibitors, buffers, colorants, fragrances, pro-fragrances, rheology modifiers, anti-ashing polymers, preservatives, insect repellents, soil repellents, water-resistance agents, suspending agents, aesthetic agents, structuring agents, sanitisers, solvents, fabric finishing agents, dye fixatives, wrinkle-reducing agents, fabric conditioning agents and deodorizers.

### Preservatives

Optionally, a soluble preservative may be added to this invention. Contamination of the product by microorganisms, which can occur through both raw materials and consumer use, can have a number of undesirable effects. These include phase separation, the formation of bacterial and fungal colonies, the emission of objectionable odours and the like. The use of a preservative is especially preferred when the composition of this invention is a liquid, as these products tend to be especially susceptible to microbial growth.

The use of a broad-spectrum preservative, which controls the growth of bacteria and fungi is preferred. Limited-spectrum preservatives, which are only effective on a single group of microorganisms may also be used, either in combination with a broad-spectrum material or in a “package” of limited-spectrum preservatives with additive activities. Depending on the circumstances of manufacturing and consumer use, it may also be desirable to use more than one broad-spectrum preservative to minimise the effects of any potential contamination.

The use of both biocidal materials, i.e. substances that kill or destroy bacteria and fungi, and biostatic preservatives, i.e. substances that regulate or retard the growth of microorganisms, may be indicated for this invention.

In order to minimise environmental waste and allow for the maximum window of formulation stability, it is preferred that preservatives that are effective at low levels be used. Typically, they will be used only at an effective amount. For the purposes of this disclosure, the term “effective amount” means a level sufficient to control microbial growth in the product for a specified period of time, i.e., two weeks, such that the stability and physical properties of it are not negatively affected. For most preservatives, an effective amount will be between about 0.00001% and about 0.5% of the total formula, based on weight. Obviously, however, the effective level will vary based on the material used, and one skilled in the art should be able to select an appropriate preservative and use level.

Preferred preservatives for the compositions of this invention include organic sulphur compounds, halogenated materials, cyclic organic nitrogen compounds, low molecular weight aldehydes, quaternary ammonium materials, dehydroacetic acid, phenyl and phenoxy compounds and mixtures thereof.

Examples of preferred preservatives for use in the compositions of the present invention include: a mixture of about 77% 5-chloro-2-methyl-4-isothiazolin-3-one and about 23% 2-methyl-4-isothiazolin-3-one, which is sold commercially as a 1.5% aqueous solution by Rohm & Haas (Philadelphia, Pa.) under the trade name Kathon; 1,2-benzisothiazolin-3-one, which is sold commercially by Avecia (Wilmington, Del.) as, for example, a 20% solution in dipropylene glycol sold under the trade name Proxel GXL; and a 95:5 mixture of 1,3 bis(hydroxymethyl)-5,5-dimethyl-2,4 imidazolidinedione and 3-butyl-2-iodopropynyl carbamate, which can be obtained, for example, as Glydant Plus from Lonza (Fair Lawn, N.J.). The preservatives described above are generally only used at an effective amount to give product stability. It is conceivable, however, that they could also be used at higher levels in the compositions on this invention to provide a biostatic or antibacterial effect on the treated articles.

### Fluorescent Whitening Agents

Many fabrics, and cottons in particular, tend to lose their whiteness and adopt a yellowish tone after repeated washing. As such, it is customary and preferred to add a small amount of fluorescent whitening agent, which absorbs light in the ultraviolet region of the spectrum and re-emits it in the visible blue range, to the compositions of this invention, especially if they are combination detergent/fabric conditioner preparations.

Suitable fluorescent whitening agents include derivatives of diaminostilbenedisulphonic acid and their alkali metal salts. Particularly, the salts of 4,4′-bis(2-anilino4-morpholino-1,3,5-triazinyl-6-amino)stilbene-2,2′-disulphonic acid, and related compounds where the morpholino group is replaced by another nitrogen-comprising moiety, are preferred. Also preferred are brighteners of the 4,4′-bis(2-sulphostyryl) biphenyl type, which may optionally be blended with other fluorescent whitening agents at the option of the formulator. Typical fluorescent whitening agent levels in the preparations of this invention range between 0.001% and 1%, although a level between 0.1% and 0.3%, by mass, is normally used. Commercial supplies of acceptable fluorescent whitening agents can be sourced from, for example, Ciba Specialty Chemicals (High Point, N.C.) and Bayer (Pittsburgh, Pa.).

### Builders

Builders are often added to fabric cleaning compositions to complex and remove alkaline earth metal ions, which can interfere with the cleaning performance of a detergent by combining with anionic surfactants and removing them from the wash liquor. The preferred compositions of this invention, especially when used as a combination detergent/softener, contain builders.

Soluble builders, such as alkali metal carbonates and alkali metal citrates, are particularly preferred, especially for the liquid embodiment of this invention. Other builders, as further detailed below, may also be used, however. Often a mixture of builders, chosen from those described below and others known to those skilled in the art will be used.

### Alkali and Alkaline Earth Metal Carbonates

Alkali and alkaline earth metal carbonates, such as those detailed in German patent application 2,321,001, published Nov. 15, 1973, are suitable for use as builders in the compositions of this invention. They may be supplied and used either in anhydrous form, or including bound water. Particularly useful is sodium carbonate, or soda ash, which both is readily available on the commercial market and has an excellent environmental profile.

The sodium carbonate used in this invention may either be natural or synthetic, and, depending on the needs of the formula, may be used in either dense or light form. Natural soda ash is generally mined as trona and further refined to a degree specified by the needs of the product it is used in. Synthetic ash, on the other hand, is usually produced via the Solvay process or as a coproduct of other manufacturing operations, such as the synthesis of caprolactam. It is sometimes further useful to include a small amount of calcium carbonate in the builder formulation, to seed crystal formation and increase building efficacy.

### Organic Builders

Organic detergent builders can also be used as nonphosphate builders in the present invention. Examples of organic builders include alkali metal citrates, succinates, malonates, fatty acid sulphonates, fatty acid carboxylates, nitrilotriacetates, oxydisuccinates, alkyl and alkenyl disuccinates, oxydiacetates, carboxymethyloxy succinates, ethylenediamine tetraacetates, tartrate monosuccinates, tartrate disuccinates, tartrate monoacetates, tartrate diacetates, oxidized starches, oxidized heteropolymeric polysaccharides, polyhydroxysulphonates, polycarboxylates such as polyacrylates, polymaleates, polyacetates, polyhydroxyacrylates, polyacrylate/polymaleate and polyacrylate/polymethacrylate copolymers, acrylate/maleate/vinyl alcohol terpolymers, aminopolycarboxylates and polyacetal carboxylates, and polyaspartates and mixtures thereof. Such carboxylates are described in U.S. Pat. Nos. 4,144,226, 4,146,495 and 4,686,062. Alkali metal citrates, nitrilotriacetates, oxydisuccinates, acrylate/maleate copolymers and acrylate/maleate/vinyl alcohol terpolymers are especially preferred nonphosphate builders.

### Phosphates

The compositions of the present invention which utilise a water-soluble phosphate builder typically contain this builder at a level of from 1 to 90% by weight of the composition. Specific examples of water-soluble phosphate builders are the alkali metal tripolyphosphates, sodium, potassium and ammonium pyrophosphate, sodium and potassium orthophosphate, sodium polymeta/phosphate in which the degree of polymerisation ranges from about 6 to 21, and salts of phytic acid. Sodium or potassium tripolyphosphate is most preferred.

Phosphates are, however, often difficult to formulate, especially into liquid products, and have been identified as potential agents that may contribute to the eutrophication of lakes and other waterways. As such, the preferred compositions of this invention comprise phosphates at a level of less than about 10% by weight, more preferably less than about 5% by weight. The most preferred compositions of this invention are formulated to be substantially free of phosphate builders.

### Zeolites

Zeolites may also be used as builders in the present invention. A number of zeolites suitable for incorporation into the products of this disclosure are available to the formulator, including the common zeolite 4A. In addition, zeolites of the MAP variety, such as those taught in European Patent Application EP-B-384,070, which are sold commercially by, for example, Ineos Silicas (UK), as Doucil A24, are also acceptable for incorporation. MAP is defined as an alkali metal aluminosilicate of zeolite P type having a silicon to aluminium ratio not exceeding 1.33, preferably within the range of from 0.90 to 1.33, more preferably within the range of from 0.90 to 1.20.

Especially preferred is zeolite MAP having a silicon to aluminium ratio not exceeding 1.07, more preferably about 1.00. The particle size of the zeolite is not critical. Zeolite A or zeolite MAP of any suitable particle size may be used. In any event, as zeolites are insoluble matter, it is advantageous to minimise their level in the compositions of this invention. As such, the preferred formulations contain less than about 10% of zeolite builder, while especially preferred compositions compress less than about 5% zeolite.

### Enzyme Stabilisers

When enzymes and especially proteases are used in liquid detergent formulations, it is often necessary to include a suitable quantity of enzyme stabiliser to temporarily deactivate it until it is used in the wash. Examples of suitable enzyme stabilisers are well-known to those skilled in the art, and include, for example, borates and polyols such as propylene glycol. Borates are especially suitable for use as enzyme stabilisers because in addition to this benefit, they can further buffer the pH of the detergent product over a wide range, thus providing excellent flexibility.

If a borate-based enzyme stabilisation system is chosen, along with one or more cationic polymers that are at least partially comprised of carbohydrate moieties, stability problems can result if suitable co-stabilisers are not used. It is believed that this is the result of borates' natural affinity for hydroxyl groups, which can create an insoluble borate-polymer complex that precipitates from solution either over time or at cold temperatures. Incorporating into the formulation a co-stabiliser, which is normally a diol or polyol, sugar or other molecule with a large number of hydroxyl groups, can ordinarily prevent this. Especially preferred for use as a co-stabiliser is sorbitol, used at a level that is at least about 0.8 times the level of borate in the system, more preferably 1.0 times the level of borate in the system and most preferably more than 1.43 times the level of borate in the system, is sorbitol, which is effective, inexpensive, biodegradable and readily available on the market. Similar materials including sugars such as glucose and sucrose, and other polyols such as propylene glycol, glycerol, mannitol, maltitol and xylitol, should also be considered within the scope of this invention.

### Fibre Lubricants

In order to enhance the conditioning, softening, wrinkle-reduction and protective effects of the compositions of this invention, it is often desirable to include one or more fibre lubricants in the formulation. Such ingredients are well known to those skilled in the art, and are intended to reduce the coefficient of friction between the fibres and yarns in articles being treated, both during and after the wash process. This effect can in turn improve the consumer's perception of softness, minimise the formation of wrinkles and prevent damage to textiles during the wash. For the purposes of this disclosure, “fibre lubricants” shall be considered non-cationic materials intended to lubricate fibres for the purpose of reducing the friction between fibres or yarns in an article comprising textiles which provide one or more wrinkle-reduction, fabric conditioning or protective benefit.

Examples of suitable fibre lubricants include oily sugar derivatives, functionalised plant and animal-derived oils, silicones, mineral oils, natural and synthetic waxes and the like. Such ingredients often have low HLB values, less than about 10, although exceeding this level is not outside of the scope of this invention.

Oily sugar derivatives suitable for use in this invention are taught in WO 98/16538, which is incorporated herein by reference. These are especially preferred as fibre lubricants, due to their ready availability and favorable environmental profile. When used in the compositions of this invention, such materials are typically present at a level between about 1% and about 10% of the finished composition. Another class of acceptable ingredients includes hydrophilically-modified plant and animal oils and synthetic triglycerides. Suitable and preferred hydrophilically modified plant, animal and synthetic triglyceride oils and waxes have been identified as effective fibre lubricants. Such suitable plant derived triglyceride materials include hydrophilically modified triglyceride oils, e.g. sulphated, sulphonated, carboxylated, alkoxylated, esterified, saccharide modified, and amide derivatised oils, tall oils and derivatives thereof, and the like. Suitable animal derived triglyceride materials include hydrophilically modified fish oil, tallow, lard, and lanolin wax, and the like. An especially preferred functionalised oil is sulphated castor oil, which is sold commercially as, for example, Freedom SCO-75, available from Noveon (Cleveland, Ohio).

Various levels of derivatisation may be used provided that the derivatisation level is sufficient for the oil or wax derivatives to become soluble or dispersible in the solvent it is used in so as to exert a fibre lubrication effect during laundering of fabrics with a detergent containing the oil or wax derivative.

If this invention includes a functionalised oil of synthetic origin, preferably this oil is a silicone oil. More preferably, it is either a silicone poly ether or amino-functional silicone. If this invention incorporates a silicone polyether, it is preferably of one of the two general structures shown below:

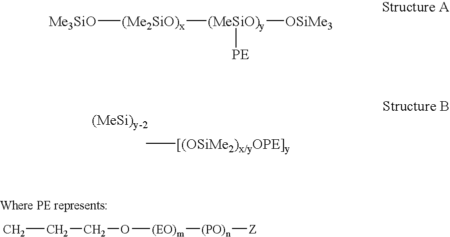

where Me represents methyl; EO represents ethylene oxide; PO represents 1,2 propylene oxide; Z represents either a hydrogen or a lower alkyl radical; x, y, m, n are constants and can be varied to alter the properties of the functionalised silicone.

A molecule of either structure can be used for the purposes of this invention. Preferably, this molecule contains more than 30% silicone, more than 20% ethylene oxide and less than 30% propylene oxide by weight, and has a molecular weight of more than 5,000. An example of a suitable, commercially available such material is L-7622, available from Crompton Corporation, (Greenwich, Conn.)

Amino-functional silicones come in a wide variety of structures, which are well-known to those skilled in the art. These are also useful in the context of this invention, although over time many of these materials can oxidize on fabrics, leading to yellowing. As this is not a desirable property of a fabric care composition, if an amino-functional silicone is used, preferably it is a hindered amine light stabilised product, which exhibits a greatly reduced tendency to show this behavior. A commercially available example of such a silicone is Hydrosoft, available from Rhodia—US (Cranbury, N.J.)

When the use of a fibre lubricant is elected, it will generally be present as between 0.1% and 15% of the total composition weight.

### Bleach Catalyst

An effective amount of a bleach catalyst can also be present in the invention. A number of organic catalysts are available such as the sulphonimines as described in U.S. Pat. Nos. 5,041,232; 5,047,163 and 5,463,115.

Transition metal bleach catalysts are also useful, especially those based on manganese, iron, cobalt, titanium, molybdenum, nickel, chromium, copper, ruthenium, tungsten and mixtures thereof. These include simple water-soluble salts such as those of iron, manganese and cobalt as well as catalysts containing complex ligands.

Suitable examples of manganese catalysts containing organic ligands are described in U.S. Pat. No. 4,728,455, U.S. Pat. No. 5,114,606, U.S. Pat. No. 5,153,161, U.S. Pat. No. 5,194,416, U.S. Pat. No. 5,227,084, U.S. Pat. No. 5,244,594, U.S. Pat. No. 5,246,612, U.S. Pat. No. 5,246,621, U.S. Pat. No. 5,256,779, U.S. Pat. No. 5,274,147, U.S. Pat. No. 5,280,117 and European Pat. App. Pub. Nos. 544,440, 544, 490, 549,271 and 549,272. Preferred examples of these catalysts include Mn^{IV}₂(u-O)₂(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂(CIO₄)₂, Mn^{IV}₄(u-O)₆(1,4,7-triazacyclononane)₄ (CIO₄)₄, Mn^{III}Mn^{IV}₄(u-O)₁(u-OAc)₂(1,4,7-trimethyl-1,4,7-triazacyclononane)₂(CIO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. No. 4,430,243 and U.S. Pat. No. 5,114,611. Other examples of complexes of transition metals include Mn gluconate, Mn(CF₃SO₃)₂, and binuclear Mn complexed with tetra-N-dentate and bi-N-dentate ligands, including [bipy₂Mn^{III}(u-O)₂Mn^{IV}bipy₂]-(CIO₄)₃.

Iron and manganese salts of aminocarboxylic acids in general are useful herein including iron and manganese aminocarboxylate salts disclosed for bleaching in the photographic colour processing arts. A particularly useful transition metal salt is derived from ethylenediaminedisuccinate and any complex of this ligand with iron or manganese.

Another type of bleach catalyst, as disclosed in U.S. Pat. No. 5,114,606, is a water soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylitol, arabitol, adonitol, meso-erythritol, meso-inositol, lactose and mixtures thereof. Especially preferred is sorbitol.

Other bleach catalysts are described, for example, in European Pat. App. Pub. Nos. 408,131 (cobalt complexes), 384,503 and 306,089 (metallo-porphyrins), U.S. Pat. No. 4,728,455 (manganese/multidenate ligand), U.S. Pat. No. 4,711,748 (absorbed manganese on aluminosilicate), U.S. Pat. No. 4,601,845 (aluminosilicate support with manganese, zinc or magnesium salt), U.S. Pat. No. 4,626,373 (manganese/ligand), U.S. Pat. No. 4,119,557 (ferric complex), U.S. Pat. No. 4,430,243 (Chelants with manganese cations and non-catalytic metal cations), and U.S. Pat. No. 4,728,455 (manganese gluconates).

Useful catalysts based on cobalt are described in WO 96/23859, WO 96/23860 and WO 96/23861 and U.S. Pat. No. 5,559,261. WO 96/23860 describe cobalt catalysts of the type [CoₙLₘXₚ]^{z}Y_{z}, where L is an organic ligand molecule containing more than one heteroatom selected from N, P, O and S; X is a co-ordinating species; n is preferably 1 or 2; m is preferably 1 to 5; p is preferably 0 to 4 and Y is a counterion. One example of such a catalyst is N,N′-Bis(salicylidene)ethylenediaminecobalt (II). Other cobalt catalysts described in these applications are based on Co(III) complexes with ammonia and mono-, bi-, tri- and tetradentate ligands such as [Co(NH₃)₅OAc]²^{₊} with Cl⁻, OAc⁻, PF₆⁻, SO₄⁼, and BF₄⁻ anions.

Certain transition-metal containing bleach catalysts can be prepared in the situ by the reaction of a transition-metal salt with a suitable chelating agent, for example, a mixture of manganese sulphate and ethylenediaminedisuccinate. Highly coloured transition metal-containing bleach catalysts may be co-processed with zeolites to reduce the colour impact.

When present, the bleach catalyst is typically incorporated at a level of about 0.0001 to about 10% by wt., preferably about 0.001 to about 5% by weight.

### Hydrotropes

In many liquid and powdered detergent compositions, it is customary to add a hydrotrope to modify product viscosity and prevent phase separation in liquids, and ease dissolution in powders.

Two types of hydrotropes are typically used in detergent formulations and are applicable to this invention. The first of these are short-chain functionalised amphiphiles. Examples of short-chain amphiphiles include the alkali metal salts of xylenesulphonic acid, cumenesulphonic acid and octyl sulphonic acid, and the like. In addition, organic solvents and monohydric and polyhydric alcohols with a molecular weight of less than about 500, such as, for example, ethanol, isoporopanol, acetone, propylene glycol and glycerol, may also be used as hydrotropes.

### Soil Release Agents

In order to prevent the resoiling of fabrics during and after the wash, one or more soil release agents may also be added to the products of this invention. Many different types of soil release agents are known to those skilled in the art, depending on the formulation in use and the desired benefit. The soil release agents useful in the context of this invention are typically either antiredeposition aids or stain-repelling finishes. Examples of anti-redeposition agents include soil release polymers, such as those described in WO 99/03963, which is incorporated herein by reference.

In addition, the cationic polymers of this invention are particularly advantageous when used in conjunction with a stain-repelling finish. Such materials are typically either fluoropolymers or fluorosurfactants, although the use of other amphiphilic materials with extremely hydrophobic lyophobes, such as silicone surfactants, is also conceivable. Non-limiting examples of suitable anionic fluorosurfactants are taught in U.S. Pat. No. 6,040,053, which is incorporated herein by reference. Without wishing to be bound by theory, it is believed that the cationic polymers of this invention coordinate to the fabric surface and act as a substrate and deposition aid for the stain-repelling finish. When an antiredeposition aid or stain-repelling finish is used, it is typically applied as 0.05% to 10% of the finished composition.

The following examples will more fully illustrate the embodiments of this invention. All parts, percentages and proportions referred to herein and in the appended claims are by weight unless otherwise illustrated. Physical test methods are described below.

### EXAMPLES

TABLE 1
Details of the three formulations

| Material/ | | | |
|---|---|---|---|
| manufacturer | Control | Formulation A | Formulation 1 |
| Linear alkyl | 9 | 9 | 9 |
| benzene sulphonate | | | |
| Alcohol ethoxylate - | 4.45 | 4.45 | 4.45 |
| 7EO | | | |
| F-77 (BASF) | 0 | 0 | 1 |
| Prifac 5908 from | 4.5 | 4.5 | 4.5 |
| Uniqema | | | |
| LR-400 from Dow | 0 | 0.2 | 0.2 |
| Amerchol | | | |
| NaOH | 1.28 | 1.28 | 1.28 |
| MEA | 1.3 | 1.3 | 1.3 |
| NaCl | 0.25 | 0.25 | 0.25 |
| Propylene glycol | 2 | 2 | 2 |
| Dequest 2066 | 1 | 1 | 1 |
| Tinopal CBS-X | 0.02 | 0.02 | 0.02 |
| Acusol | 0.016 | 0.016 | 0.016 |
| PVP-K15 | 0.1 | 0.1 | 0 |
| Dye | 0.00098 | 0.00098 | 0.00098 |
| Perfume | 0.38 | 0.38 | 0.38 |
| Water | to 100 | to 100 | to 100 |

A control formulation (formulated without cationic polymer) was prepared as well as comparative formulation A (formulated without the polymeric non-ionic surfactant) and formulation 1 according to the present invention. The values in the table are weight percentages and the formulations were in liquid form.

### Explanation of the Ingredients

All ingredients are quoted as percentages by weight of total formulation.

F-77 is an ethylene oxide/propylene oxide block copolymer having an average molecular weight of 6600. It is available under the Pluronic (Trademark) name from BASF.

The cationic polymer used in the formulations is a cationic cellulosic polymer LR-400 from Dow Amerchol.

Prifac 5908 is palmkernel fatty acid having an iodine value lower than 1.0.

The non-soap detersive surfactants used in the above formulation are linear alkyl benzene sulphonate and alcohol ethoxylate-7EO.

Optional ingredients incorporated were dyes, perfume, opacifier (Acusol), optical brightener (Tinopal CBS-X), sequestrant (Dequest 2066), hydrotrope (propylene glycol), salt (NaCl) and neutraliser (MEA and NaOH).

An anti-redeposition polymer (PVP-K15) was included in the control formulation and for formulation A. As the anti-redeposition data shows, formulation 1 according to the invention (and which does not include the anti-redeposition polymer) shows a marked improvement in reducing redeposition of soil in comparison to formulation A, which is not according to the invention.

The three formulations were tested for softening efficacy by an expert panel. The formulations were also tested for cleaning, on three different fabric types, by running an anti-redeposition experiment. Two other formulations were also tested for anti-redeposition on cotton fabric. These differed from formulation 1 only in that polymeric non-ionic surfactants of differing molecular weights were used.

### Softness Evaluation

The softness evaluation used a panel of 10 trained assessors to assess the softness value of machine laundered cotton fabric articles by the three formulations. The fabric articles were cotton swatches each being the same size (20 cm by 20 cm). The softness scale used went upwards from 1, with 1 being not soft (so the higher the number the better). Each panellist assessed various items at random from the three washes and gave each laundered swatch a softness score. The score stated in table 2 is the average (mean) value for softness recorded.

The laundering process used was as follows and was the same for all three formulations:—

### Washing Machine

Computer controlled Miele (Trademark) FLA machines
60° C., cotton wash
26° FH—(French Degree of Water Hardness)
2.5 kg load of cotton fabric swatches of the same size
Product introduced to wash via dosing ball—120 gm per wash
Monadic assessment, 10 assessors (expert panel).

Table 2 records the average (mean) value for the softness of a fabric article laundered with each formulation.

TABLE 2
Softness Values

| Formulation | Mean Score |
|---|---|
| Control | 2.8 |
| Formulation A | 3.5 |
| Formulation 1 | 3.8 |

The results for both comparative formulation A and formulation 1 (according to the invention) show a significant benefit in comparison to the control formulation for softness. Formulation 1 according to the invention even shows a greater softening value in comparison to formulation A. As it is believed that it is a cationic polymer/soap complex that provides the softening benefit, then we can see that as softness is increased in formulation 1 in comparison to formulation A, then we believe that deposition of soap is increased by adding the non-ionic block polymer surfactant according to the invention.

### Anti-Redeposition Data

Redeposition of soil was quantified by using a change in reflectance of the fabric. Such a technique is well known in the art. The reflectance was expressed by measuring the initial reflectance at 460 nm, with contribution due to UV excluded, (hereafter referred to as R460*) of the swatches using a HunterLab (trademark) UltraScan (trademark) XE reflectometer. Following washing the individual swatches were air-dried and the final reflectance values for the swatches at R460* determined. The change in reflectance ΔR is determined by subtracting the initial reflectance from the final reflectance; the average change in reflectance for the different fabric swatches laundered with the three different formulations is presented in table 3 below.

TABLE 3
Anti-redeposition Data

| | | | Knitted |
|---|---|---|---|
| | Cotton | Polycotton | polycotton |
| | ΔR460* | ΔR460* | ΔR460* |
| Formulation | reading | reading | reading |
| Control | −2.305 | −0.865 | 0.1 |
| Formulation A | −2.95 | −1.44 | −1.295 |
| Formulation 1 | −1.9525 | −1.01 | −0.8025 |

From table 3, it is clear that formulation 1 has a clear benefit in terms of increased anti-redeposition in comparison to formulation A (which does not include the polymeric non-ionic surfactant), in that there has been a lower redeposition of soil onto the fabric as expressed by the ΔR460* value for reflectance.

A further anti-redeposition experiment was carried out using the method outlined above. The formulations tested utilised the same ingredients as per formulation 1, only this time the molecular weight of the polymeric non-ionic surfactant used was varied. The level of incorporation was 1% by weight as before. The three polymeric non-ionic surfactants were sourced from BASF under the Pluronic trademark.

F-77 is an ethylene oxide/propylene oxide block copolymer having an average molecular weight of 6600. It is available under the Pluronic (Trademark) name from BASF.

L-62 is an ethylene oxide/propylene oxide block copolymer having an average molecular weight of 2450. It is available under the Pluronic (Trademark) name from BASF.

F-88 is an ethylene oxide/propylene oxide block copolymer having an average molecular weight of 11400. It is available under the Pluronic (Trademark) name from BASF.

The tests were carried out on cotton fabric swatches. The results are expressed in table 4 and show useful benefits for soil anti-redeposition for a range of polymeric non-ionic surfactants with molecular weights from ˜2400 to 11500 Daltons.

TABLE 4
Anti-redeposition data for different mol. Wt.
polymeric non-ionic surfactants.

| | Average Molecular | |
|---|---|---|
| | weight of | |
| | polymeric non- | |
| | ionic surfactant | ΔR460* |
| Formulation | (Daltons) | reading |
| Control | — | −2.305 |
| Formulation A | — | −2.95 |
| Formulation 1 | 6600 | −1.9525 |
| (F-77) | | |
| Formulation 2 | 2450 | −2.29 |
| (L-62) | | |
| Formulation 3 | 11400 | −1.22 |
| (F-88) | | |

1. A softening in the wash detergent composition comprising:—
(a) at least 1% by weight of a detersive surfactant other than soap, with a molecular weight below 1000 Daltons;
(b) at least 1% by weight of a C₆-C₃₀ soap;
(c) 0.005% to 5% by weight of a polymeric non-ionic surfactant having a molecular weight above 2200 Daltons; and,
(d) 0.001% to 15% by weight of one or more water soluble cationic polymers capable of forming a complex with (b).

2. The composition according to claim 1 wherein the polymeric non-ionic surfactant is a block polymer.

3. The composition according to claim 1 wherein the polymeric non-ionic surfactant has a molecular weight of less than 13000 Daltons.

4. The composition according to claim 1 wherein the polymeric non-ionic surfactant comprises ethylene oxide and propylene oxide blocks.

5. The composition according to claim 1 comprising from 0.01 to 4%, preferably from 0.05 to 3.5%, most preferably from 0.075 to 2.5% by weight of the polymeric non-ionic surfactant.

6. The composition according to claim 1 wherein at least one cationic polymer is selected from the group consisting of dimethyl diallyl ammonium chloride/acrylamide copolymers, dimethyl diallyl ammonium chloride/acrylic acid/acrylamide terpolymers, vinylpyrrolidone/methyl vinyl imidazolium chloride copolymers, polydimethyl diallyl ammonium chloride, starch hydroxypropyl trimmonium chloride, polymethacryl amidopropyl trimethyl ammonium chloride, acrylamidopropyl trimmonium chloride/acrylamide copolymers, guar hydroxypropyl trimonium chloride, and hydroxyethyl cellulose derivatised with trimethyl ammonium substituted epoxide.

7. The composition according to claim 5, wherein at least one cationic polymer is a cationic substituted siloxane or polyquaternium 10.

8. The composition according to claim 1, wherein the one or more cationic polymers are present at a level of from 0.01 to 10%, preferably from 0.025 to 7.5%, more preferably from 0.03 to 5%, for example from 0.05 to 4.5% and especially 0.09 to 2% by weight of total composition.

9. The composition according to claim 1, wherein the soap is present at a level of from 1 to 25%, preferably from 1 to 15%, more preferably from 1.25 to 10%, most preferably from 1.5 to 8% by weight.

10. The composition according to claim 1, wherein the soap is a C₈-C₂₆, preferably C₈-C₂₄, more preferably C₈-C₁₈ soap.

11. The composition according to claim 1, wherein the detersive surfactant other than soap is present at a level of from 1 to 90%, preferably from 1.5 to 85%, more preferably from 2 to 80% by weight of total composition.

12. The composition according to claim 1, wherein the detersive surfactant other than soap is selected from non-ionic surfactant, anionic surfactant or mixtures thereof.

13. The composition according to claim 12, wherein the anionic surfactant is an alkali or alkaline earth metal salt of either; a fatty alcohol sulphate (preferably ethoxylated, in particular sodium lauryl ether sulphate); an alkylbenzene sulfonate (preferably linear alkylbenzene sulfonate), or mixtures thereof.

14. The composition according to claim 12, wherein the non-ionic surfactant is C₈-C₃₅ alkoxylated, preferably C₈-C₃₀, more preferably C₁₀-C₂₄, most preferably C₁₀-C₁₈.

15. The composition according to claim 3, wherein the molecular weight of the polymeric non-ionic surfactant is from 2400 to 11500 Daltons.

16. A method for increasing the deposition of soap onto a textile, comprising the steps:
(a) provision of a softening in the wash laundry composition according to claim 1; and,
(b) contacting one or more textile articles with the composition at one or more points during the main wash of a laundering process; and,
(c) allowing the textile articles to dry or mechanically tumble-drying them.

17. A method to reduce the redeposition of soil onto a textile, comprising the steps:
(a) provision of a softening in the wash laundry composition as described herein; and,
(b) contacting one or more textile articles with the composition at one or more points during the main wash of a laundering process; and,
allowing the textile articles to dry or mechanically tumble-drying them.
